(19) United States
(12) Patent Application Publication
(10) Pub. No.: US 2003/0046398 A1
(43) Pub. Date: Mar. 6, 2003

(54) Method and system for managing a plurality of console devices in a network

(76) Inventors: Charles Buckley, Fort Collins, CO (US); Joseph Jay Foss, Boulder, CO (US); Benjamin Asher Short, Longmont, CO (US)

Correspondence Address: HOFFMAN WARNICK & D'ALESSANDRO, LLC, 3 E-COMM SQUARE, ALBANY, NY, 12207

(21) Appl. No.: 09/941,329

(22) Filed: Aug. 29, 2001

(51) Int. Cl. G06F 15/16

(52) U.S. Cl. 709/227

(57) ABSTRACT

A method and system for managing a plurality of console devices in a network is provided. Specifically, under the present invention a plurality of console devices interconnected over a hybrid hardwired/addressable network is provided. An availability of one of the console devices is checked. Once checked, a shared session from a current user of the checked console device is requested. If the request is granted, a shared session of the console device is then started. Once started, the console device is accessed on a peer to peer basis over the hybrid network.

### BACKGROUND OF THE INVENTION

1. Technical Field

The present invention generally relates to a method and system for managing a plurality of console devices in a network. More particularly, the present invention provides a method and system for accessing a console device during a shared session.

2. Background Art

With the explosion of e-business initiatives, business entities are increasingly implementing more complex computing networks. It is often the case that an entity will implement a network that includes a heavy concentration of servers, workstations, and other console devices. However, when these devices fail, troubleshooting and repair becomes both complex and time consuming. Generally, this is due to the disparate nature of computing networks. For example, it is possible for a network to include a main server that communicates with several sub-servers. Each sub-server may in turn communicate with another server, workstation, or other device. Thus, when a device fails, a system administrator must often physically access the device to repair the problem. The requirement of physical access can be especially overwhelming when the network is spread out over a large geographical area. For example, a system administrator in New York may be required to troubleshoot a collection of devices in Chicago. Accordingly, the system administrator must either travel to Chicago, or attempt to communicate his/her advice to someone who can physically access the failed device. In either case, the repair cannot be made efficiently.

Heretofore, attempts have been made at providing improved management systems. In one such attempt, a video signal can be exported from one location to another. Although this may allow a system administrator to troubleshoot from a remote location, a large amount of equipment is required to send and decrypt the video signal. In another attempt, resources can be shared between multiple computer systems. However, such resource sharing is limited to the software layer of a computer system. Specifically, there is no allocation for a system administrator to access the hardware layer of the computer system. Accordingly, the troubleshooting potential is limited. Other attempts have been to access the hardware layer, but these attempts fail to scale to massive numbers of systems. In yet another attempt, a system is provided that allows for multiple users to engage in a network meeting. In particular, multiple computer systems are connected to a central system. The central server allows each user to view and interact with each other. Such a system, however, has little or no use in troubleshooting; especially in the event that the central server fails.

In view of the foregoing, there exists a need for a method and system for managing a plurality of console devices that are geographically or physically at distance. There also exists a need for reliable communications to managed devices that also scales to massive numbers of such devices.

Specifically, there exists a need for multiple users to be able to participate in shared sessions of a console device through which both the software and hardware layer of the console device can be accessed.

### SUMMARY OF THE INVENTION

The present invention overcomes the drawbacks of existing systems by providing a method and system for managing a plurality of console devices in a network. Specifically, under the present invention, a computing network that includes a system server; at least one terminal concentrator (TC) server connected to the system server; one or more multiplexor connected to each TC server; and at least one console device connected to each multiplexor are provided. Users can access the system server to start a shared session and access one of the console devices. In general, the connection between a console device, a multiplexor, and a TC server is made via a hardwired serial port connection. The connection between the TC server and the system server can be made via either a hardwired connection or an addressable connection (e.g., using TCP/IP technology). When forming the connection between the TC server and the system server via an addressable connection, the resulting network is a reliable hybrid network.

According to a first aspect of the present invention, a method for managing a plurality of console devices over a network is provided. The method comprises the steps of: (1) providing a plurality of console devices interconnected over a hybrid network; (2) checking an availability of one of the console devices; (3) requesting a shared session from a current user of the checked console device; (4) starting the shared session; and (5) accessing the console device on a peer to peer basis over the hybrid network during the shared session.

According to a second aspect of the present invention, a method for managing a plurality of console devices over a network is provided. The method comprises the steps of: (1) providing a plurality of console devices interconnected over a hardwired serial port network; (2) checking an availability of one of the console devices prior to attempting to access the console device; (3) requesting a shared session from a current user of the console device; (4) starting a shared session via an addressable connection; (5) accessing the console device on a peer to peer basis over the hardwired serial port network; and (6) performing system console access of the console device.

According to a third aspect of the present invention, a method for managing a plurality of console devices over a network is provided. The method comprises the steps of: (1) providing a plurality of console devices interconnected over a hybrid network; (2) a current user of one of the console devices inviting a new user to join a shared session of the console device; (3) starting the shared session of the console device; and (4) accessing the console device on a peer to peer basis over the hybrid network.

According to a fourth aspect of the present invention, a system for managing a console device in a network is provided. The system comprises: (1) a system server; (2) a terminal concentrator server connected to the system server; (3) a multiplexor connected to the terminal concentrator server; (4) a console device connected to the multiplexor; and (5) a program product stored on the system server for allowing users to open a shared session and access the console device.

According to a fifth aspect of the present invention, a system for managing a plurality of console devices in a network is provided. The system comprises: (1) a system server; (2) a plurality of terminal concentrator servers connected to the system server; (3) a separate multiplexor connected to each of the terminal concentrator servers; (4) at least one console device hardwired to each multiplexor; and (5) a program product stored on the system server for allowing users to open a shared session of a particular console device, and to access the particular console device on a peer to peer basis.

According to a sixth aspect of the present invention, a program product stored on a recordable medium for managing a plurality of console devices interconnected over a hardwired serial port network is provided. When executed, the program product comprises: (1) program code configured to access one of a plurality of console devices on a peer to peer basis; (2) program code configured to invite a user to join a shared session of one of the console devices; (3) program code configured to request a shared session from a current user of one of the console devices during a shared session; and (5) program code configured to regain delegated control of the console devices. Therefore, the present invention provides a method and system for managing a plurality of console devices in a network.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a server system having a console system according to the present invention.

FIG. 2 depicts a box diagram of users managing console devices.

FIG. 3 depicts a box diagram of the console system of FIG. 1.

FIG. 4 depicts a method flow chart according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

In general, the present invention provides a method and system for managing a plurality of console devices in a network. As used herein, the term console device refers to any programmable computer system (e.g., workstation, server, laptop, personal digital assistant, etc.). To manage a console device, users can engage in a shared session to access the hardware and/or software layer of the console device. As used herein, the term multiplexor refers to serial or addressable network hardware devices used to fan out individual signals or packets to multiple destinations from and origination point. As used herein, the term Terminal Concentrator server is any programmable computer system attached to a multiplexor and system server. As used herein the term serial port refers to the low-level console input/output device of a computer system used for hardware and software management purposes. This could be serial protocol,, Universal Server Bus (USB), or data packet based in the future.

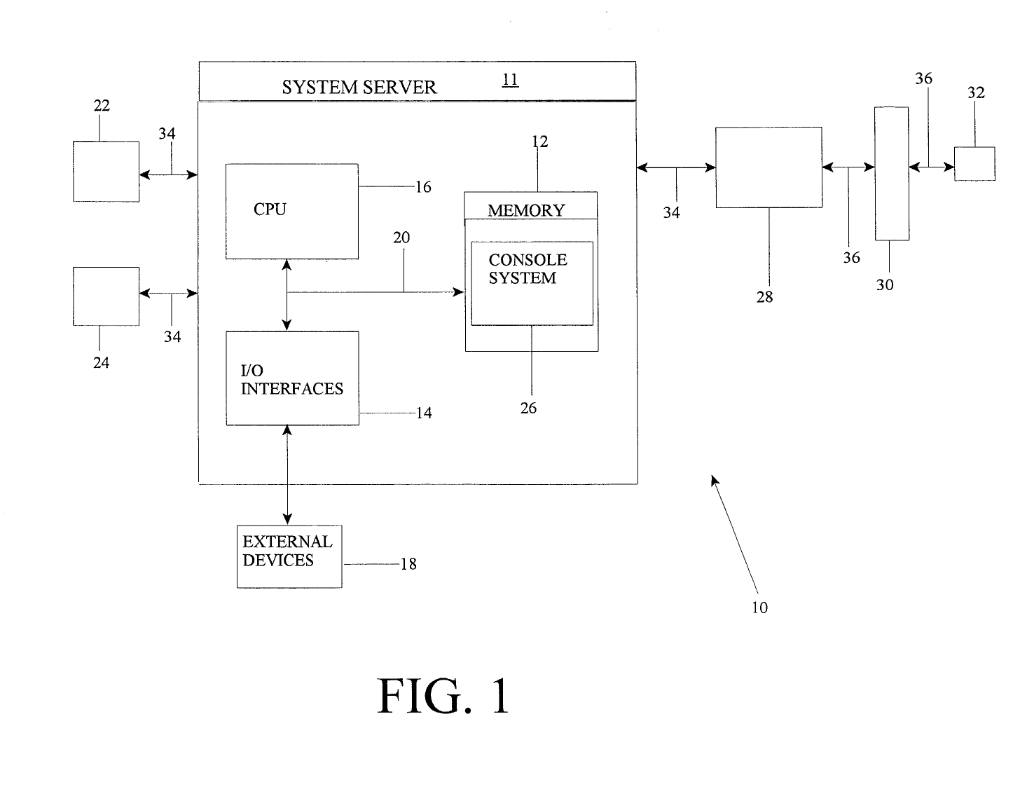

Referring now to FIG. 1, console management system 10 is shown. As depicted users 22 and 24 can access system server 11 to manage console device 32. Under the present invention console device 32 is preferably connected to system server 11 via multiplexor 30 and terminal concentrator (TC) server 28. Connections 36 between console device 32 and multiplexor 30, and between multiplexor 30 and TC server 28 are preferably hardwired serial port connections. By implementing connections 36 as a hardwired serial port connection, as opposed to an Ethernet-based connection, reliable bandwidth is obtained.

Users 22 and 24 (e.g., system administrators) access system server 11 to start a shared session for accessing and managing console device 32 on a peer to peer basis. During the shared session, both the hardware and software layer of console device 32 can be accessed. This level of access allows optimal management of console device 32. Communication between system server 11 and users 22 and 24, and between system server 11 and TC server 28 occurs via communication links 34. Communications links 34 can include a direct hardwired connection (e.g., serial port) to the system server 11, or an addressable connection such as a remote system in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system. For the purposes of the present invention, in instances where users 22 and 24 are connected to system server 11 from a remote location, the shared session is opened/started “via an addressable connection,” or on an “addressable network layer level.” By implementing connections 34 as addressable connections scalability is achieved by deploying one or more system servers 11.

As further shown in FIG. 1, system server 11 generally comprises memory 12, input/output interfaces 14, a central processing unit (CPU) 16, external devices/resources 18, and bus 20. Stored in memory 12 of system server 11 is console system 26 (shown in FIG. 1 as a software product). Console system 26 will be described in more detail below but generally provides the functionality by which shared sessions and console device 32 access will occur. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the system server 11 and likewise may comprise any known type of transmission link, including electrical, optical, wireless, etc. In addition, although not shown, additional components, such as cache memory, communication systems, system software, etc., may be incorporated into system server 11.

It should be appreciated that although not shown, TC server 28 and console device 32 can include similar components (e.g., memory 12) as system server 11. Such components are not shown in FIG. 1 for brevity purposes only. It is further understood that the present invention can be realized in hardware, software, or a combination of hardware and software. Moreover, any kind of computer/server system(s)—or other apparatus adapted for carrying out the methods described herein—is suited. A typical combination of hardware and software could be a general purpose computer system with a computer program that, when loaded and executed, controls system server 11 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

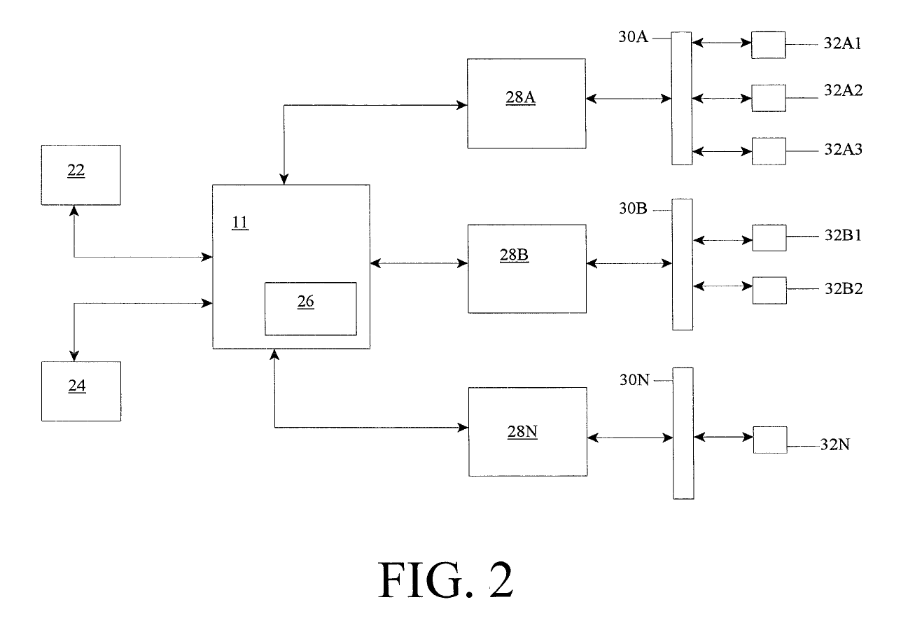

Referring now to FIG. 2, a more detailed depiction of the present invention is shown. As shown, users 22 and 24 are in communication with system server 11. As indicated above, such communication can occur via either a hardwired connection or an addressable connection. Users 22 and 24 will use system server 11 to manage console devices 32A-N. Console devices 32A-N are connected via a hardwired serial port network. Specifically, each console device is hardwired to a multiplexor 30A-N. Each multiplexor 30A-N is similarly hardwired to a TC server 28A-N. This hardwired connection provides reliable bandwidth. Each TC server 28A-N is connected then to system server 11 via either a hardwired or addressable connection. When TC servers 28A-N and system server 11 are connected via an addressable connection, the resulting network is a hybrid of hardwired connections (i.e., between the console devices, multiplexors and TC servers) and addressable connections (i.e., between the TC servers and the system server).

If user 22 desired to access console device 32A1, he/she could do so by accessing system server 11 and providing the address for console device 32A1. Specifically, user 22 would log into console system 26 and provide the proper address for console device 32A1. As shown, the network could have any quantity of TC servers, multiplexors, and console devices. Accordingly, user 22 will preferably provide the proper address for console device 32A1. Such an address could include a TC server identification as well as a console device identifier (e.g., port number, device name, etc.). Once console device 32A1 has been accessed, user can invite user 24 to join him/her in a shared session.

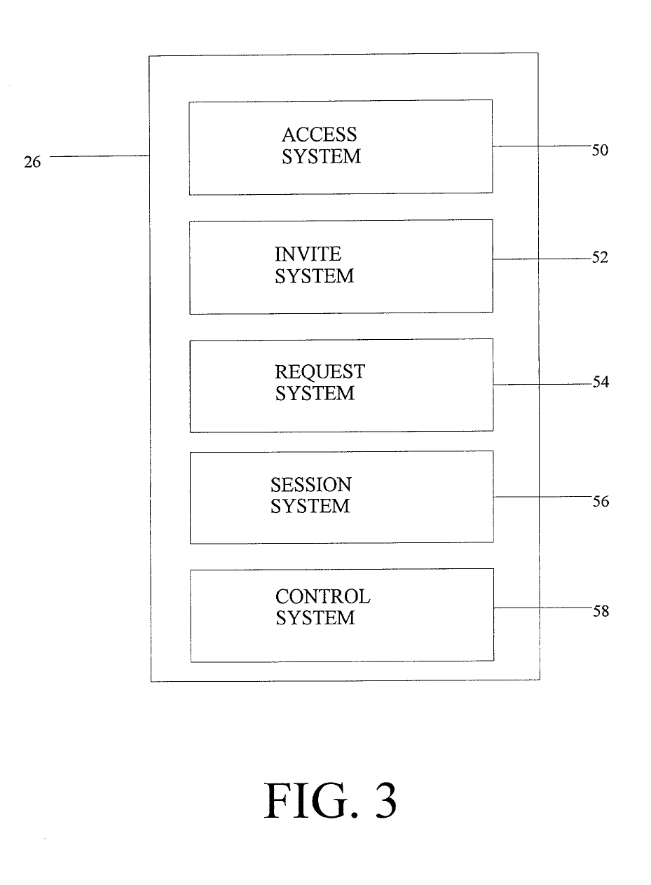

Once a shared session is started, console device 32A1 is accessed on a peer to peer basis. Specifically, console device 32A1 is accessed as if user 22 and 24 were physically utilizing the console device 32A1. Thus, management of console device 32A1, by the user is direct and transparently occurring through a hierarchy of other devices. Unlike previous systems the hierarchy is not apparent to the user. In contrast, management occurs as if a direct linked were formed from users 22 and 24 to console device 32A1. As will be further described in conjunction with FIG. 3, console system 26 provides various functions such as the capability to invite a user to join a shared session, the capability to request a shared session from a current user of a console device, the capability of delegate control of a console device to another user, and the capability to regain delegated control.

It should be understood that FIG. 2 is meant to convey that any quantity of console devices 32A-N, multiplexors 30A-N, TC servers 28A-N and system servers 11 could be implemented under the present invention. The architecture, connections, and software illustrated herein provide an optimal way to manage console devices 32A-N. In addition, it should be understood that console system 26 could reside on one or more of the TC servers 28A-N (either in lieu of or in addition to on system server 11). This allows users 22 and 24 to still manage a console device in the event system server 11 fails. Moreover, a shared session under the present invention can include any quantity of users. Two users 22 and 24 are shown for illustrative purposes only.

Referring now to FIG. 3, a more detailed depiction of console system 26 is shown. As depicted, console system 26 includes access system 50, invite system 52, request system 54, session system 56, and control system 58. Access system 50 provides a way for users 22 or 24 to log into console system 26 to manage a console device. Specifically, as indicated above, a user will designate a particular console device according to its address. The address as well as a user password or the like can be designated at a log-on screen. Once log-on is complete, the designated console device is accessed for management. For example, if user 22 is required to troubleshoot console device 32A1 (FIG. 2) he/she will utilize access system to log into console system and access console device 32A1. If user 22 so desires, he/she can then invite user 24 to join a shared session of console device 32A1. To accomplish this, invite system 52 is utilized. Invite system 52 can be any system capable of providing communication between users 22 and 24. Preferably, invite system 52 provides a way for user 22 to ask user 24 if he/she wishes to join a shared session for a particular console device as well as a way for user 24 to accept or deny user's 22 invitation. Moreover, since user 22 has already designated the particular console device 32A1, user 24 need not repeat the designation. In contrast, user 24 will be invited to join in a shared session for console device 32A1 currently being accessed by user 22.

In an alternate embodiment user 24 can request a shared session with a current user 22 of console device 32A1 via request system 54. Request system 54 functions similarly to invite system 52 with respect to communication between users 22 and 24. However, in this instance, user 22 must approve user's 24 request before a shared session can be started. Invite system 52 and request system 54 allow multiple user to collaborate on management of a console device. This is especially useful where users 22 and 24 are located in different geographical locations and/or when users 22 and 24 have different levels of expertise.

Once an invitation to join a shared session or a request to start a shared session has been accepted, session system 56 will start the shared session and both users 22 and 24 can access console device 32A1. As indicated above, depending on the connections between users 22 and 24 and system server 11 as well as between system server 11 and the pertinent TC server 28, the shared session can be on a TCP/IP layer or other level. Specifically, if users 22 and 24 as well as the relevant TC server are communicating with system server 11 from a remote location (i.e., via an addressable connection), the shared session is started at a TCP/IP layer level. However, it is possible for one or both users 22 and 24 to be communicating with system server 11 via an addressable connection while TC server communicates with system server 11 via a hardwired connection, and vice versa.

Once the shared session is started, users 22 and 24 access console device 32A1. During the access, control of console device 32A1 can be delegated back and forth via control system 58. Specifically, under a preferred embodiment, control is initially held by the current/first user (e.g., 22) of console device 32A1. Current user 22 then has the option to delegate control of console device 32A1 to new user 24. This allows user 24 to fully participate in the management of console device 32A1. Once control has been delegated to user 24, user 22 can then regain control via control system 58.

Under the present invention, access of console device 32A1 can occur at two levels. One level is at the software level. This allows user 22 and 24 to access the software (e.g., operating system, applications, etc.) of console device 32A1. When accessing software, users 22 and 24 can collaborate on projects and/or troubleshoot the software in console device 32A1. A second level of access allows users 22 and 24 to access the hardware of console device 32A1 (referred to herein as “system console access”). For example, if the operating system of console device 32A1 has failed, users 22 and 24 can still access console device 32A1 for troubleshooting. As indicated above, access to console device 32A1 occurs on a peer to peer basis. Accordingly, user 22 manages console device 32A1 as if it were the computer system he/she was using to access console system 26. For example, if user 22 wished to access BIOS functions only available from the console device 32A1 he/she could do so. Also if the user wished to send special hardware signals, HALT, reboot, electrical power control (on/off) they could do so to the hardware of console device 32A1. Moreover, if the user needed to execute elevated or supreme system privilege, often restricted to the console they could be allowed such. No existing system provides such a capability independent of Operating System and hardware platforms such as SUN Microsystems, IBM, HP, etc. In contrast other systems only provide software access or are relegated to a particular hardware platform or require additional hardware dongles, signal device transmitters etc.

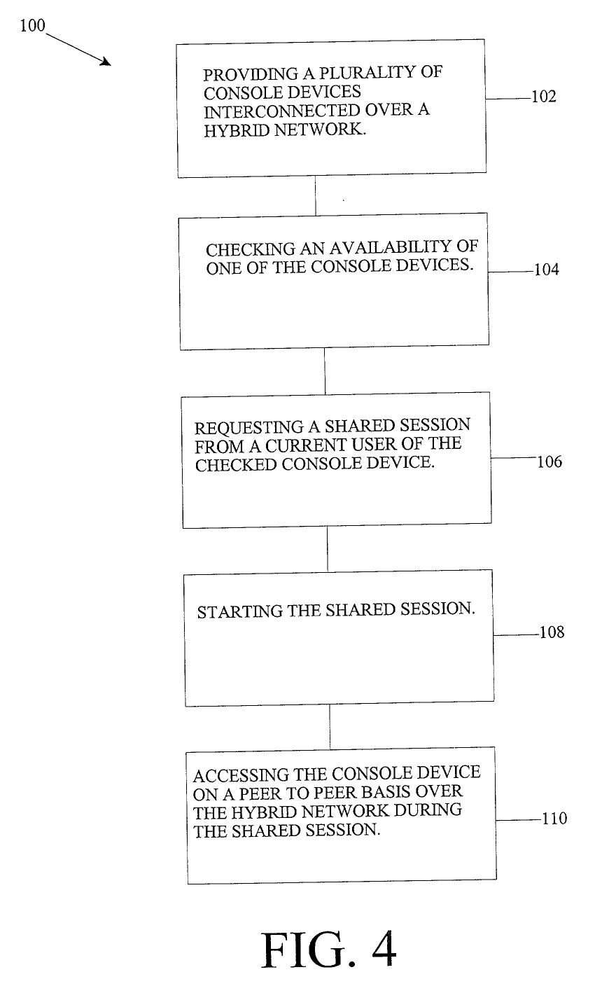

Referring now to FIG. 4, a flow chart of a method 100 according to the present invention is shown. First step 102 is to provide a plurality of console devices interconnected over a hybrid network. Second step 104 is to check an availability of one of the console devices. Third step 106 is to request a shared session from a current user of the checked console device. Fourth step 108 of method 100 is to start the shared session. Fifth step 110 is to access the console device on a peer to peer basis over the hybrid network during the shared session.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for managing a plurality of console devices over a network, comprising the steps of:
providing a plurality of console devices interconnected over a hybrid network;
checking an availability of one of the console devices;
requesting a shared session from a current user of the checked console device;
starting the shared session; and
accessing the console device on a peer to peer basis over the hybrid network during the shared session.

2. The method of claim 1, wherein the hardwired network is a hardwired serial port network.

3. The method of claim 1, wherein the shared session is started from a remote location.

4. The method of claim 1, wherein the shared session is started at via an addressable connection.

5. The method of claim 1, further comprising the step of performing system console access of the accessed consoled device.

6. The method of claim 1, wherein the console devices are computer systems.

7. A method for managing a plurality of console devices in a network, comprising the steps of:
providing a plurality of console devices interconnected over a hardwired serial port network;
checking an availability of one of the console devices prior to attempting to access the console device;
requesting a shared session from a current user of the console device;
starting a shared session via an addressable connection;
accessing the console device on a peer to peer basis over the hardwired serial port network; and
performing system console access of the console device.

8. The method of claim 7, wherein the console devices are computer systems.

9. A method for managing a plurality of console devices in a network, comprising the steps of:
providing a plurality of console devices interconnected over a hybrid serial port network;
a current user of one of the console devices inviting a new user to join a shared session of the console device;
starting the shared session of the console device; and
accessing the console device on a peer to peer basis over the hybrid serial port network.

10. The method of claim 9, wherein the shared session is started via an addressable connection.

11. The method of claim 9, further comprising the step of performing system console access of the console device.

12. A system for managing a console device in a network, comprising:
a system server;
a terminal concentrator server connected to the system server;
a multiplexor connected to the terminal concentrator server;
a console device connected to the multiplexor; and
a program product stored on the system server for allowing users to open a shared session and access the console device.

13. The system of claim 12, wherein the terminal concentrator server, the multiplexor and the device are interconnected over a hardwired serial port network.

14. The system of claim 12, wherein the terminal concentrator server and the system server are interconnected over a hardwired serial port network.

15. The system of claim 12, wherein the terminal concentrator server and the system server are addressably connected.

16. The system of claim 12, wherein the console device is a computer system.

17. The system of claim 12, wherein the shared session is opened by the users via an addressable connection.

18. The system of claim 12, wherein the console device is accessed by the users on a peer to peer basis.

19. The system of claim 12, wherein the program product, when executed, comprises:
program code configured to access one of a plurality of console devices on a peer to peer basis over a hardwired serial port network;
program code configured to invite a user to join a shared session of one of a plurality of console devices interconnected over a hardwired serial port network;
program code configured to request a shared session from a current user of one of a plurality of console devices interconnected over a hardwired serial port network;
program code configured to delegate control of a console device during a shared session; and
program code configured to regain delegated control of a console device.

20. A system for managing a plurality of console devices in a network, comprising:
a system server;
a plurality of terminal concentrator servers connected to the system server;
a separate multiplexor connected to each of the terminal concentrator servers;
at least one console device hardwired to each multiplexor; and
a program product stored on the system server for allowing users to open a shared session of a particular console device, and to access the particular console device on a peer to peer basis.

21. The system of claim 20, wherein the shared sessions are opened via an addressable connection.

22. The system of claim 20, wherein the console devices are computer systems.

23. The system of claim 20, wherein the system server, the terminal concentrator servers, the multiplexors, and the console devices are interconnected over the hardwired serial port network.

24. The system of claim 20, wherein the system server and the terminal concentrator servers are addressably connected.

25. The system of claim 20, wherein the program product, when executed, comprises:
program code configured to access one of a plurality of console devices on a peer to peer basis over a hardwired serial port network;
program code configured to invite users to join a shared session of one of a plurality of console devices interconnected over a hardwired serial port network;
program code configured to request a shared session from a current user of one of a plurality of console devices interconnected over a hardwired serial port network;
program code configured to delegate control of a console device during a shared session; and
program code configured to regain delegated control of a console device.

26. A program product stored on a recordable medium for managing a plurality of console devices interconnected over a hardwired serial port network, which when executed, comprises:
program code configured to access one of a plurality of console devices on a peer to peer basis;
program code configured to invite a user to join a shared session of one of the console devices;
program code configured to request a shared session from a current user of one of the console devices;
program code configured to delegate control of one of the console devices during a shared session; and
program code configured to regain delegated control of the console device.
